(19) United States
(12) Patent Application Publication
(10) Pub. No.: US 2026/0063591 A1
(43) Pub. Date: Mar. 5, 2026

(54) LASER INDUCED ULTRASONIC INSPECTION APPARATUS

(71) Applicant: SEIKO EPSON CORPORATION, Tokyo (JP)

(72) Inventors: Kohei YAMADA, SHIOJIRI-SHI (JP); Shoichi TAKASUNA, SHIOJIRI-SHI (JP)

(21) Appl. No.: 19/309,650

(22) Filed: Aug. 26, 2025

(30) Foreign Application Priority Data
Aug. 27, 2024 (JP) 2024-145728

(51) Int. Cl. G01N 29/24; G01N 29/06; G01N 29/12; G01N 29/34; G01N 29/44

(52) U.S. Cl. CPC G01N 29/2418; G01N 29/069; G01N 29/12; G01N 29/343; G01N 29/348; G01N 29/4436; G01N 2291/0289

(57) ABSTRACT

A laser induced ultrasonic inspection apparatus including: a head including a light source configured to irradiates an object with pulse-shaped first laser light, a first signal generator configured to generate a pulse control signal, and a laser interferometer configured to detect vibration induced by the radiation of the first laser light; a moving stage at which the object is placed; and a second signal generator configured to generate a stage control signal, the laser interferometer including a light source configured to irradiate the object with second laser light, a light modulator, and a light receiver configured to receive the second laser light traveling via the light modulator and the object.

The present application is based on, and claims priority from JP Application Serial Number 2024-145728, filed Aug. 27, 2024, the disclosure of which is hereby incorporated by reference herein in its entirety.

### BACKGROUND

### 1. Technical Field

The present disclosure relates to a laser induced ultrasonic inspection apparatus.

### 2. Related Art

JP-A-04-147053 discloses a laser induced ultrasonic flaw detection method for irradiating a reflective vibrating plate with pulse-shaped, ultrasonic wave generating laser light to generate an ultrasonic wave in the reflective vibrating plate, transmitting the generated ultrasonic wave to an object under inspection, causing the reflective vibrating plate to receive the ultrasonic wave reflected off the location of a defect in the object under inspection, and using ultrasonic wave detecting laser light to detect vibration of the reflective vibrating plate resulting from received the ultrasonic wave.

JP-A-04-147053 is an example of the related art.

When the pulse-shaped, ultrasonic wave generating laser light described in JP-A-04-147053 is used, a reference signal is required for oscillation of the laser light. A signal generator is used to generate the reference signal.

Furthermore, in the laser induced ultrasonic flaw detection method described in JP-A-04-147053, identification of the position of a defect in the in-plane direction of the surface of the object under inspection requires moving the object under inspection with respect to the ultrasonic wave generating laser light. In this case, it is conceivable to employ a method for placing the object under inspection at a moving stage and detecting vibration generated in the object under inspection with the ultrasonic wave detecting laser light while moving the object under inspection. A reference signal used to control the moving stage and generated by a signal generator different from that described above is used to drive the moving stage.

The signal generators described above, however, increase the number of parts of the laser induced ultrasonic inspection apparatus, and the increase hinders reduction in size of the laser induced ultrasonic inspection apparatus.

The propagation distance of the ultrasonic wave in the object under inspection can be observed at multiple observation positions by processing the timing at which the ultrasonic wave generating laser light is output, the timing at which the vibration is detected, and information on the position the object under inspection in synchronization with the reference signals. The position of the defect of the object under inspection can thus be identified more accurately.

It is, however, not easy to synchronize the multiple types of signal processing described above with the reference signals generated by the different signal generators.

There is therefore a challenge of realizing a laser induced ultrasonic inspection apparatus that has a small number of parts, is readily reduced in size, and readily synchronizes multiple types of signal processing using reference signals.

### SUMMARY

A laser induced ultrasonic inspection apparatus according to an application example of the present disclosure includes a head including a first laser light source configured to irradiates an object under inspection with pulse-shaped first laser light, a first signal generator configured to generate a pulse control signal used to set a repetition frequency of the first laser light, and a laser interferometer configured to use second laser light to detect vibration of the object under inspection that is derived from an ultrasonic wave induced in the object under inspection by the radiation of the first laser light; a moving stage at which the object under inspection is placed and which is configured to change a relative position of the object under inspection with respect to the head; and a second signal generator configured to generate a stage control signal used to control an operation of the moving stage, the laser interferometer including a second laser light source configured to irradiate the object under inspection with the second laser light, a light modulator configured to use a vibrator to modulate a frequency of the second laser light, a light receiver configured to receive the second laser light traveling via the light modulator and the second laser light traveling via the object under inspection, and output a light reception signal, and a signal processor configured to detect the vibration based on the light reception signal and a reference signal, the first signal generator is configured to generate the pulse control signal based on the reference signal, the second signal generator is configured to generate the stage control signal based on the reference signal, and the vibrator is a signal source of the reference signal.

### BRIEF DESCRIPTION OF THE DRAWINGS

FIG. 1 is a block diagram showing a schematic configuration of a laser induced ultrasonic inspection apparatus according to a first embodiment.

FIG. 2 is an example of the circuit diagram of a frequency converter including an n-base counter.

FIG. 3 is a timing chart showing an example of a reference signal, a displacement calculated from a light reception signal, a laser sensing signal, and a stage control signal that are input to a signal processor.

FIG. 4 is a diagrammatic view showing a state in which the optical axis of second laser light inclines by a deviation angle δ with respect to a reference line parallel to the optical axis of first laser light.

FIG. 5 is a diagrammatic view showing a case where the optical axis of the first laser light and the optical axis of the second laser light are made coaxial by using a coaxial optical system.

FIG. 6 is a functional block diagram showing functional sections provided in a stage controller in FIG. 1.

FIG. 7 is a diagrammatic view showing propagation of ultrasonic waves induced when two types of first laser light are radiated to two different locations at a surface of an object under inspection.

FIG. 8 shows an example of a trajectory as a result of scanning the object under inspection with the radiation position of the first laser light, and an example of image data produced by replacing the length of an elapsed period at each position with a color density and mapping the color density in an orthogonal coordinate system having an X-axis and a Y-axis set in the object under inspection.

FIG. 9 is a block diagram showing a schematic configuration of a laser induced ultrasonic inspection apparatus according to a second embodiment.

FIG. 10 is a block diagram showing a schematic configuration of a laser induced ultrasonic inspection apparatus according to a third embodiment.

FIG. 11 is a graph showing the waveform of a displacement of the object under inspection that is produced in association with vibration.

FIG. 12 shows an example of the trajectory as a result of scanning the object under inspection with the radiation position of the first laser light, and an example of image data produced by replacing the frequency analysis result at each position with a color density and mapping the color density in the orthogonal coordinate system having the X-axis and the Y-axis set in the object under inspection.

FIG. 13 is a block diagram showing a schematic configuration of a laser induced ultrasonic inspection apparatus in a related art.

### DESCRIPTION OF EMBODIMENTS

A laser induced ultrasonic inspection apparatus according to the present disclosure will be described below in detail based on embodiments shown in the accompanying drawings.

### 1. Related Art

A related art will first be described.

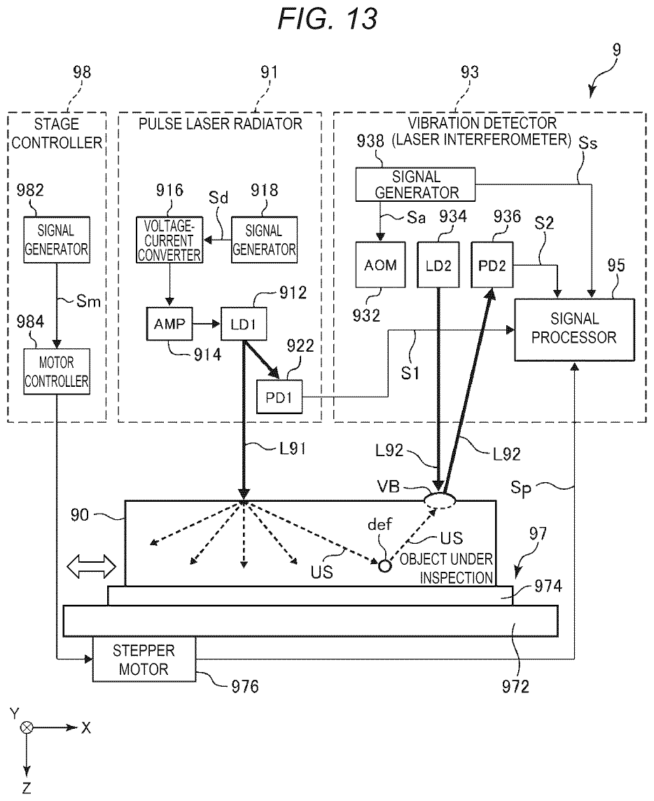

FIG. 13 is a block diagram showing a schematic configuration of a laser induced ultrasonic inspection apparatus 9 in the related art. Note in the drawings in the present application that an X-axis, a Y-axis, and a Z-axis are set as three axes orthogonal to one another. Opposite directions parallel to the X-axis are referred to as an X-axis direction. The same applies to a Y-axis direction and a Z-axis direction.

The laser induced ultrasonic inspection apparatus 9 shown in FIG. 13 includes a pulse laser radiator 91, a vibration detector 93 (laser interferometer), a moving stage 97, and a stage controller 98.

The pulse laser radiator 91 includes a laser light source 912, an amplifier 914, a voltage-current converter 916, a signal generator 918, and a photodiode 922.

The signal generator 918 generates a pulse control signal Sd. The voltage-current converter 916 converts the pulse control signal Sd, which is a pulse-shaped voltage signal, into a current signal. The amplifier 914 amplifies the current signal and supplies the amplified current signal to the laser light source 912. The pulse laser radiator 91 then irradiates an object under inspection 90 with laser light L91 output from the laser light source 912. An ultrasonic wave US is thus induced in the object under inspection 90. The generated ultrasonic wave US propagates in the object under inspection 90, and when there is a defect def in the object under inspection 90, the ultrasonic wave US is reflected there and reaches a surface of the object under inspection 90. The ultrasonic wave US having reached the surface induces vibration VB of the surface. The photodiode 922 receives part of the laser light L91 and outputs a laser sensing signal S1.

The vibration detector 93 is a laser interferometer, and includes an acousto-optical modulator (AOM) 932, a laser light source 934, a photodiode 936, a signal generator 938, and a signal processor 95.

The signal generator 938 generates a drive signal Sa, which is necessary for the operation of the acousto-optical modulator 932, and a reference signal Ss, which serves as a time reference for multiple types of signal processing in the signal processor 95. The vibration detector 93 irradiates the object under inspection 90 with laser light L92 output from the laser light source 934. The laser light L92 is thus subjected to a Doppler shift due to the vibration VB of the surface. Thereafter, the photodiode 936 receives the laser light L92 having been subjected to the Doppler shift and the laser light L92 having passed through the acousto-optical modulator 932, and outputs a light reception signal S2. The vibration VB is electrically detected through measurement of the Doppler shift based on the optical interference effect.

The moving stage 97 includes a base 972, a placement section 974, and stepper motors 976. The base 972 supports the placement section 974 in a movable manner. The placement section 974 is movable in the X-axis and Y-axis directions with the object under inspection 90 placed thereon. That is, the moving stage 97 includes a stepper motor 976 that moves the placement section 974 in the X-axis direction, and a stepper motor 976 that moves the placement section 974 in the Y-axis direction.

The stage controller 98 includes a signal generator 982 and a motor controller 984. The signal generator 982 generates a stage control signal Sm, which is a pulse signal. The motor controller 984 generates a signal used to control the rotation of the stepper motors 976 based on the input stage control signal Sm. The stepper motors 976 each rotate its output shaft in a predetermined rotational direction, by a predetermined amount of rotation, and at a predetermined rotational speed in accordance with the signal output from the motor controller 984. The placement section 974 can thus be moved with respect to the base 972 in a target direction, by a target amount of movement, and at a target moving speed.

The stepper motors 976 each include an encoder that is not shown. The signal processor 95 acquires signals (object-under-inspection position signal Sp) output from the encoders. The object-under-inspection position signal Sp represents the position of the object under inspection 90 in the X-Y plane.

The signal processor 95 acquires the laser sensing signal S1 output from the photodiode 922, the light reception signal S2 output from the photodiode 936, the reference signal Ss output from the signal generator 938, and the object-under-inspection position signal Sp output from the stepper motors 976. Based on the signals described above, the signal processor 95 acquires an elapsed period Δt from the output of the laser light L91 to the detection of the vibration VB, and positional information (X, Y) corresponding to the position irradiated with the laser light L91. The elapsed period Δt reflects the position of the point where the ultrasonic wave US is reflected. The signal processor 95 determines whether the defect def is present and the position thereof based on the elapsed period Δt.

In the laser induced ultrasonic inspection apparatus 9, the pulse laser radiator 91 includes the signal generator 918, the vibration detector 93 includes the signal generator 938, and the stage controller 98 includes the signal generator 982.

The signal generators 918, 938, and 982, however, cause an increase in the number of parts of the laser induced ultrasonic inspection apparatus 9. It is therefore difficult to reduce the size of the laser induced ultrasonic inspection apparatus 9 of the related art.

Therefore, in a first embodiment described later, providing a light modulator using a vibrator attempts to achieve, for example, reduction in the number of parts, reduction in size, reduction in power consumption of the vibration detector (laser interferometer). A laser induced ultrasonic inspection apparatus that is readily reduced in size and excels in portability. Furthermore, using the vibrator described above as a signal source of the reference signals allows omission of the signal generators 918, 938, and 982. Further reduction in the number of parts and the size of the laser induced ultrasonic inspection apparatus can thus be achieved. Note that the signal generator 938 in the related art may be used as the signal source of the reference signals, but that it is preferable to use the vibrator as described above from the viewpoint of reduction in the number of parts, cost reduction, and other factors.

### 2. First Embodiment

A laser induced ultrasonic inspection apparatus according to a first embodiment will next be described.

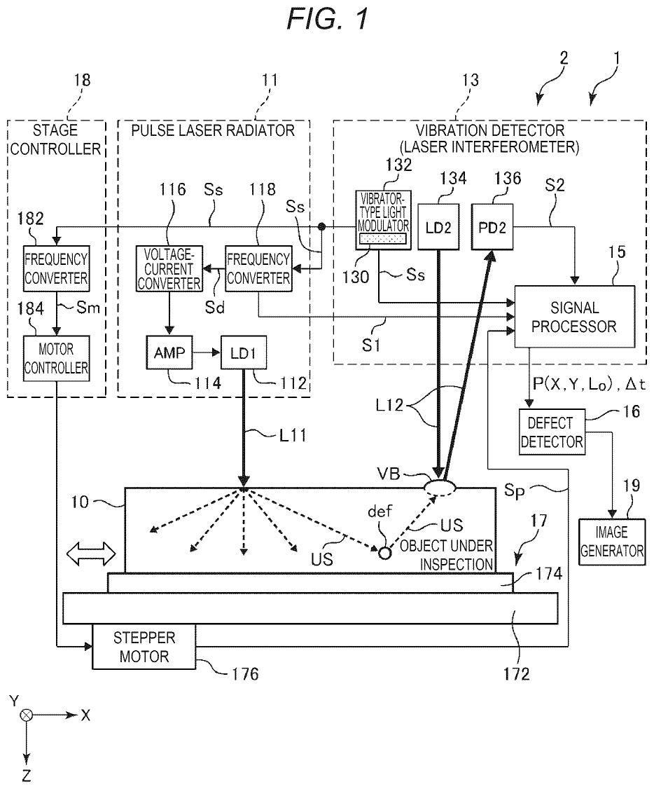

FIG. 1 is a block diagram showing a schematic configuration of a laser induced ultrasonic inspection apparatus 1 according to the first embodiment.

The laser induced ultrasonic inspection apparatus 1 shown in FIG. 1 includes a head 2, a moving stage 17, a stage controller 18, a defect detector 16, and an image generator 19.

The head 2 includes a pulse laser radiator 11 and a vibration detector 13.

The pulse laser radiator 11 includes a first laser light source 112, an amplifier 114, a voltage-current converter 116, and a frequency converter 118 (first signal generator). In the pulse laser radiator 11, the first laser light source 112 outputs pulse-shaped first laser light L11 based on the pulse control signal Sd output from the frequency converter 118. An object under inspection 10 is then irradiated with the pulse-shaped first laser light L11 output from the first laser light source 112. The ultrasonic wave US is thus induced in the object under inspection 10. The generated ultrasonic wave US radially propagates in the object under inspection 10, and when there is a defect def in the object under inspection 10, the ultrasonic wave US is reflected there and reaches a surface of the object under inspection 10. The ultrasonic wave US having reached the surface induces the vibration VB accompanied by a displacement of the surface.

The vibration detector 13 is a laser interferometer, and includes a light modulator 132 using a vibrator 130, a second laser light source 134, a photodiode 136 (light receiver), and a signal processor 15.

The vibration detector 13 irradiates the object under inspection 10 with second laser light L12 output from the second laser light source 134. The second laser light L12 is thus subjected to the Doppler shift due to the vibration VB of the surface. The second laser light L12 having been subjected to the Doppler shift is then received by the photodiode 136. The vibration VB is electrically detected through measurement of the Doppler shift based on the interference effect of the second laser light L12, that is, through an optical heterodyne method.

Specifically, the second laser light L12 output from the second laser light source 134 is, for example, split into two parts by a light splitter that is not shown, one of the two parts being incident on the light modulator 132, and the other being incident on the object under inspection 10. The light modulator 132 modulates the frequency of the second laser light L12, and generates reference light containing a modulation signal. In the object under inspection 10, the second laser light L12 is subjected to the Doppler shift, and object light containing a surface vibration signal is generated. The reference light and the object light are caused to interfere with each other, and light resulting from the interference is received by the photodiode 136. The light reception signal S2 containing the modulation signal and the surface vibration signal is thus output from the photodiode 136. The signal processor 15 demodulates the surface vibration signal from the light reception signal S2, and calculates the displacement and displacement speed of the surface of the object under inspection 10.

The light modulator 132 uses the vibration of the vibrator 130 to impart the modulation signal to the second laser light L12, and uses the vibrator 130 as a signal source to generate the reference signal Ss. The light modulator 132 includes a vibrator oscillation circuit that is not shown but causes the vibrator 130 to oscillate. The vibrator oscillation circuit can be configured with a small number of parts, so that the reference signal Ss can be generated with a significant increase in the number of parts avoided. Furthermore, the vibrator 130 is allowed to oscillate with a low voltage, so that the power consumption of the vibrator oscillation circuit can be suppressed to a low level. The laser induced ultrasonic inspection apparatus 1 can therefore operate not only with an external power supply but with an internal power supply such as a primary battery or a secondary battery.

Note that the head 2 may include an enclosure that is not shown. The enclosure may house the pulse laser radiator 11 and the vibration detector 13. The laser induced ultrasonic inspection apparatus 1 is thus favorably installed.

The moving stage 17 includes a base 172, a placement section 174, and stepper motors 176. The base 172 supports the placement section 174 in a movable manner. The placement section 174 is movable in the X-axis and Y-axis directions with the object under inspection 10 placed thereon. The stepper motors 176 move the placement section 174 in the X-axis and Y-axis directions.

The stage controller 18 includes a frequency converter 182 (second signal generator) and a motor controller 184. The frequency converter 182 generates the stage control signal Sm, which is a pulse signal. The motor controller 184 generates a signal used to rotate the output shafts of the stepper motors 176 based on the input stage control signal Sm. The stepper motors 176 each rotate its output shaft in a predetermined rotational direction, by a predetermined amount of rotation, and at a predetermined rotational speed in accordance with the signal output from the motor controller 184. The placement section 174 can thus be moved with respect to the base 172 in a target direction, by a target amount of movement, and at a target movement speed.

The stepper motors 176 each include an encoder that is not shown. The signal processor 15 acquires signals (object-under-inspection position signal Sp) output from the encoders. The object-under-inspection position signal Sp represents the position of the object under inspection 10 in the X-Y plane.

The signal processor 15 acquires the laser sensing signal S1 output from the frequency converter 118, the light reception signal S2 output from the photodiode 136, the reference signal Ss output from the light modulator 132, and the object-under-inspection position signals Sp output from the stepper motors 176. Based on the signals described above, the signal processor 15 acquires the elapsed period Δt from the output of the first laser light L11 to the detection of the vibration VB, and the positional information (X, Y) corresponding to the position irradiated with the first laser light L11.

The defect detector 16 acquires and analyzes the elapsed period Δt corresponding to the positional information (X, Y). The defect detector 16 then detects the defect def contained in the object under inspection 10 based on the result of the analysis. Since the elapsed period Δt reflects the position of the point where the ultrasonic wave US is reflected, whether the defect def is present and the position thereof are determined based on the elapsed period Δt.

The image generator 19 generates image data containing the result of the detection of the vibration VB based on the result of the analysis. Examples of the result of the detection of the vibration VB may include the depth of the defect def and the position thereof in the X-Y plane. This image data allows visual inspection of the object under inspection 10. The generated image data can therefore contribute to assistance in understanding the result of the inspection.

In the thus configured laser induced ultrasonic inspection apparatus 1, the vibration detector 13 is provided with the light modulator 132 using the vibrator 130. In the light modulator 132, the second laser light L12 is radiated to the vibrator 130 that is vibrating to impart the modulation signal to the second laser light L12, so that the reference light is generated. The vibrator 130 is also used as a signal source of the reference signal Ss. The reference signal Ss is input to the signal processor 15, used as a time reference for the multiple types of signal processing, and also used to generate the pulse control signal Sd and the stage control signal Sm. Therefore, in the laser induced ultrasonic inspection apparatus 1, the signal generators 918, 938, and 982 in the related art can be omitted, and the multiple types of signal processing in the signal processor 15 are readily synchronized with each other. As a result, a laser induced ultrasonic inspection apparatus 1 that has a small number of parts, is readily reduced in size, and excels in portability is provided.

Each portion of the laser induced ultrasonic inspection apparatus 1 will be described below in detail.

### 2.1. Pulse Laser Radiator

The pulse laser radiator 11 shown in FIG. 1 outputs the pulse-shaped first laser light L11 having a predetermined repetition frequency toward the object under inspection 10.

The first laser light source 112 outputs the pulse-shaped first laser light L11. Examples of the first laser light source 112 may include an Nd:YAG laser, a CO₂ laser, an Er:YAG laser, a titanium sapphire laser, an alexandrite laser, a ruby laser, a dye laser, a fiber laser, an excimer laser, and a semiconductor laser. Among the above, a semiconductor laser is preferably used. The semiconductor laser can contribute to reduction in size, weight, and power consumption of the first laser light source 112. Furthermore, the semiconductor laser can readily perform pulse oscillation through direct modulation, and can output the pulse-shaped first laser light L11 at low cost. In addition, the semiconductor laser may include as necessary a metal package such as a CAN package, a ceramic package, or any other element housing package.

The repetition frequency of the pulse-shaped first laser light L11 is not particularly limited to a specific frequency, but is preferably higher than or equal to 1 Hz but lower than or equal to 1000 Hz.

The pulse energy of the pulse-shaped first laser light L11 is set as appropriate in accordance with the material and other factors of the object under inspection 10 and is not particularly limited to a specific value, but is preferably greater than or equal to 1 μJ/pulse, more preferably, greater than or equal to 10 μJ/pulse but smaller than or equal to 10 J/pulse. When the object under inspection 10 is a hard object such as a concrete block or a metal block, it is preferable to select high pulse energy of about 1 mJ/pulse, and when the object under inspection 10 is a soft object such as an object made of resin, it is preferable to select low pulse energy of about 1 μJ/pulse.

The amplifier 114 amplifies a current signal to be supplied to the first laser light source 112. Note that the amplifier 114 may be provided as necessary, and may be omitted when amplification is not necessary for driving the first laser light source 112.

The voltage-current converter 116 converts a voltage signal output from the frequency converter 118 into a current signal.

The reference signal Ss output from the light modulator 132 is input to the frequency converter 118. The frequency converter 118 generates the pulse control signal Sd based on the reference signal Ss. The pulse control signal Sd is converted into a current signal by the voltage-current converter 116 and supplied to the first laser light source 112 via the amplifier 114. The first laser light source 112 determines a repetition cycle of the pulses of the first laser light L11 based on the current signal. The frequency converter 118 includes, for example, a frequency dividing circuit that divides the frequency of the reference signal Ss by n, and an n-base counter. The parameter n represents a positive integer.

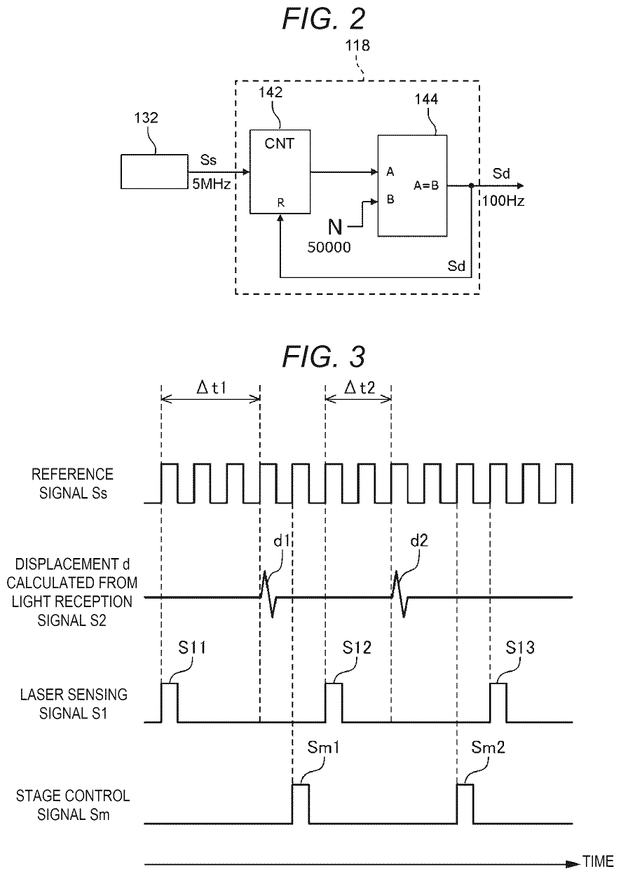

FIG. 2 is an example of the circuit diagram of the frequency converter 118 including an n-base counter. The frequency converter 118 shown in FIG. 2 includes a first circuit 142 and a second circuit 144.

The reference signal Ss output from the light modulator 132 is input to the first circuit 142. The first circuit 142 has the function of counting the pulses of the reference signal Ss and outputting the count. The pulse control signal Sd output from the second circuit 144 is further input as a reset signal R to the first circuit 142. The first circuit 142 has the function of resetting the count to zero when the reset signal R is input thereto.

The count and a base number N are input to the second circuit 144. The base number N is set in accordance, for example, with the repetition frequency of the first laser light L11. The second circuit 144 has the function of outputting pulses when A=B is satisfied, where A represents the count, and B represents the base number N. The pulse serves as the pulse control signal Sd. A specific example of the above description may be a case where assuming that the frequency of the reference signal Ss is 5 MHz and the base number N is equal to 50000, the pulses of the pulse control signal Sd are output when the count becomes 50000. In this case, the frequency of the pulse control signal Sd is down-converted into 100 Hz.

Using the thus configured frequency converter 118 allows omission of the signal generator 918 in the related art. Since the frequency converter 118 described above can be configured with a relatively small number of parts, the number of parts can be further reduced in the laser induced ultrasonic inspection apparatus 1.

### 2.2. Vibration Detector

As described above, the vibration detector 13 shown in FIG. 1 detects the generated vibration VB of the surface of the object under inspection 10, and outputs the light reception signal S2 containing the modulation signal and the surface vibration signal. The vibration detector 13 is preferably, for example, the laser interferometer disclosed in JP-A-2022-038156. The laser interferometer includes a light modulator using a vibrator and therefore contributes to reduction in size, weight, and power consumption of the vibration detector 13.

The light modulator 132 using the vibrator 130 may, for example, be the light modulator disclosed in JP-A-2022-038156. Examples of the vibrator 130 may include a quartz crystal vibrator, a silicon vibrator, and a ceramic vibrator. The quartz crystal vibrator may be an AT vibrator, a tuning-fork-type vibrator, or any other vibrator. The vibrators described above are vibrators that utilize a mechanical resonance phenomenon, and therefore each have a high Q-value and allow stabilization of the natural frequency. The S/N ratio (signal-to-noise ratio) of the modulation signal imparted to the second laser light L12 can therefore be readily increased. Furthermore, using a vibrator having a high Q-value as the vibrator 130 also allows an increase in the S/N ratio of the reference signal Ss generated by the light modulator 132, so that the S/N ratios of various signals based on the reference signal Ss can also be increased.

The second laser light source 134 may, for example, be any of the laser light sources disclosed in JP-A-2022-038156. Out of the disclosed laser light sources, using a semiconductor laser such as a vertical cavity surface emitting laser (VCSEL) allows further reduction in the size of the vibration detector 13.

The photodiode 136 (light receiver) receives light as a result of the interference between the reference light (second laser light L12 having traveled via light modulator 132) and the object light (second laser light L12 having traveled via object under inspection 10), and outputs the light reception signal S2.

The light modulator 132 uses the vibrator 130 to impart the modulation signal to the second laser light L12.

The light modulator 132 includes the vibrator oscillation circuit, which uses the vibrator 130 as a signal source to generate the reference signal Ss, as described above. Examples of the vibrator oscillation circuit may include an inverter-type oscillation circuit and a Colpitts-type oscillation circuit. The oscillation circuits described above can each generate a reference signal Ss that is highly stable in terms of frequency by using the vibrator 130 having a high Q-value for mechanical resonance. Furthermore, using the vibrator 130 as a signal source can reduce the power required for generation of the reference signal Ss, contributing also to reduction in power consumption of the vibration detector 13. Note that “using the vibrator 130 as a signal source” means that causing the vibrator 130 to vibrate and using an electric signal generated based on the vibration and having a predetermined frequency.

Based on the laser sensing signal S1, the light reception signal S2, and the reference signal Ss, the signal processor 15 calculates (measures) the elapsed period Δt from the output of the first laser light L11 to the detection of the vibration VB.

To realize the function of calculating the elapsed period Δt out of the functions of the signal processor 15, for example, the preprocessor and the demodulator disclosed in JP-A-2022-038156 are used. The preprocessor performs preprocessing on the light reception signal S2 based on the reference signal Ss, and the demodulator demodulates the signal on which the preprocessing has been performed into the surface vibration signal based on the reference signal Ss.

When the ultrasonic wave US generated by the radiation of the first laser light L11 is reflected off the defect def shown in FIG. 1, the vibration VB is induced at the surface of the object under inspection 10. The vibration VB is accompanied by changes in the displacement and the speed of the displacement of the surface of the object under inspection 10. The signal processor 15 detects the vibration VB by extracting the changes in the displacement and the displacement speed. The vibration VB can thus be accurately detected in a noncontact manner. The signal processor 15 then measures the elapsed period Δt from the output of the first laser light L11 to the detection of the vibration VB. The elapsed period Δt reflects the propagation distance of the ultrasonic wave US for the period from the time when the ultrasonic wave US is generated to the time when the ultrasonic wave US is reflected off the defect def and reaches the surface. The signal processor 15 can accurately measure the elapsed period Δt by using the reference signal Ss as a time reference. Note that the elapsed period Δt can be calculated, for example, by counting the number of pulses of the reference signal Ss.

In the present embodiment, the pulse control signal Sd output from the frequency converter 118 is input as the laser sensing signal S1 to the signal processor 15. The photodiode 922 in the related art can therefore be omitted in the present embodiment. The laser sensing signal S1 is a signal that is the same as the signal input to the first laser light source 112 (pulse control signal Sd), and therefore accurately reflects the timing at which the first laser light L11 is output. The elapsed period Δt can therefore be more accurately measured.

FIG. 3 is a timing chart showing an example of the reference signal Ss, a displacement d calculated from the light reception signal S2, the laser sensing signal S1, and the stage control signal Sm, which are input to the signal processor 15.

The signal processing of each of the displacement d and the laser sensing signal S1 shown in FIG. 3 is performed based on (in synchronization with) the reference signal Ss. Specifically, for example, the signal processor 15 measures, based on the reference signal Ss, an elapsed period Δt1 from the rising edge (timing at which first laser light L11 is output) of a pulse S11 of the laser sensing signal S1 shown in FIG. 3 to the detection of a displacement d1. Similarly, an elapsed period Δt2 from the rising edge (timing at which first laser light L11 is output) of a pulse S12 to the detection of a displacement d2 is measured based on the reference signal Ss. The multiple types of signal processing are thus readily synchronized with each other, so that the elapsed periods Δt1 and Δt2 can be readily and accurately measured.

The signal processor 15 acquires the positional information (X, Y) corresponding to the position irradiated with the first laser light L11 based on the object-under-inspection position signal Sp.

The signal processor 15 may store a distance Lo between the head 2 and the object under inspection 10. The distance Lo may be a value measured in advance, or a value measured by a distance measuring section that is not shown but is provided in the laser induced ultrasonic inspection apparatus 1. Examples of the distance measuring section may include a distance measuring sensor based on a time-of-flight (ToF) method and a distance measuring sensor based on a frequency modulated continuous wave (FMCW) method. A radiation position P(X, Y, Lo) is determined based on the distance Lo.

The radiation position P(X, Y, Lo) determined by the signal processor 15 and the elapsed period Δt measured by the signal processor 15 are input to the defect detector 16, which will be described later.

In the present embodiment, the signal processor 15 measures the elapsed period Δt while causing the moving stage 17 to change the relative position of the object under inspection 10 with respect to the head 2. That is, the elapsed period Δt can be acquired while the radiation position of the first laser light L11 at the surface of the object under inspection 10 is changed. The defect detector 16, which will be described later, can therefore readily acquire a data set of the radiation position P(X, Y, Lo) and the elapsed period Δt. As a result, the defect detector 16, which will be described later, can determine the distribution of the defect def contained in the object under inspection 10 based on the radiation positions P(X, Y, Lo).

The optical axis of the first laser light L11 and the optical axis of the second laser light L12 may incline with respect to each other, but are preferably parallel to each other. The distance between the radiation position of the first laser light L11 and the radiation position of the second laser light L12 can thus be fixed even when the object under inspection 10 is moved with respect to the head 2. As a result, when the position of the defect def is calculated from the elapsed period Δt, it is not necessary to make corrections associated with a change in the distance, so that the amount of calculation can be suppressed. When the optical axes are parallel to each other, information on the distance Lo may be omitted from the radiation position P(X, Y, Lo).

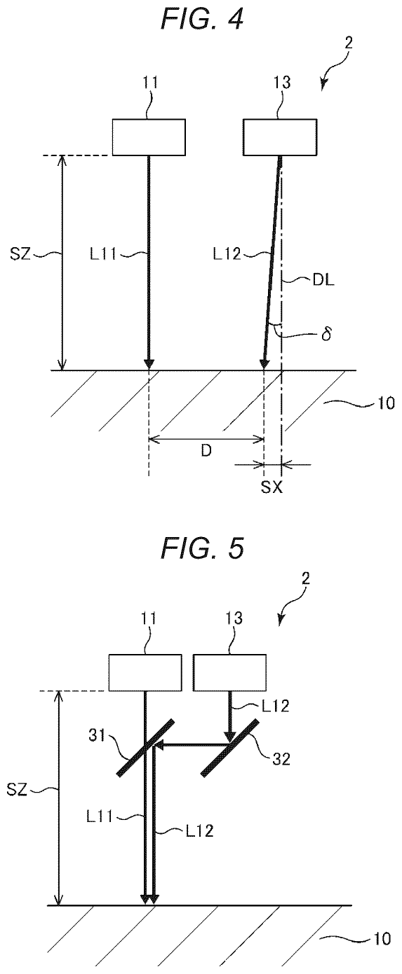

FIG. 4 is a diagrammatic view showing a state in which the optical axis of the second laser light L12 inclines by a deviation angle δ with respect to a reference line DL parallel to the optical axis of the first laser light L11. That is, FIG. 4 shows a case where the optical axes are not parallel to each other.

In FIG. 4, SZ is the distance from the head 2 to the object under inspection 10, and the optical axis of the second laser light L12 deviates from the reference line DL by the deviation angle δ. In this case, a deviation width SX between the reference line DL and the radiation position of the second laser light L12 at the object under inspection 10 is preferably smaller than or equal to 3% of the distance SZ. The situation described above can sufficiently ensure the accuracy of the detection of the defect def. As a result, in the assembly of the laser induced ultrasonic inspection apparatus 1, required assembly accuracy can be relaxed.

When the deviation width SX is smaller than or equal to 3% of the distance SZ, the deviation angle δ is smaller than or equal to 1.7°. Therefore, when the optical axes are not parallel to each other, the deviation angle δ shown in FIG. 4 is preferably smaller than or equal to 1.7°. A laser induced ultrasonic inspection apparatus 1 that is readily assembled can be realized with the accuracy of the detection of the defect def sufficiently ensured.

In FIG. 4, it is assumed that D is the distance between the optical axis of the first laser light L11 and the optical axis of the second laser light L12 at the surface of the object under inspection 10. The distance D can be calculated from the distance SZ and the deviation angle δ. The deviation angle δ is determined from the configuration of the head 2. The distance SZ is the distance Lo described above, and may be measured in advance or may be measured by a distance measuring section that is not shown. The distance D is therefore determined when the distance SZ (distance Lo) is known. The position of the defect def can therefore be calculated even when the optical axes are not parallel to each other.

The distance D is not particularly limited to a specific value, but is preferably greater than or equal to 0 mm but smaller than or equal to 50 mm. The position of the defect def to be detected is therefore readily determined with increased accuracy.

Note that when the distance D is smaller than or equal to 10 mm, it is preferable that the wavelength of the first laser light L11 and the wavelength of the second laser light L12 differ from each other, more preferably, by a value greater than or equal to 30 nm. In this case, a decrease in the accuracy of the detection of the defect def can be suppressed even when the beam of the first laser light L11 and the beam of the second laser light L12 overlap each other.

When the distance D is smaller than or equal to 10 mm, in particular, the optical axis of the first laser light L11 and the optical axis of the second laser light L12 may be made coaxial by using a coaxial optical system.

FIG. 5 is a diagrammatic view showing the case where the optical axis of the first laser light L11 and the optical axis of the second laser light L12 are made coaxial by using a coaxial optical system.

The coaxial optical system shown in FIG. 5 includes dichroic mirrors 31 and 32. The dichroic mirror 31 is disposed on the optical axis of the first laser light L11 and transmits the first laser light L11. The dichroic mirror 32 is disposed on the optical axis of the second laser light L12 and reflects the second laser light L12. The reflected second laser light L12 is reflected off the dichroic mirror 31 so as to overlap an optical axis of the reflected second laser light L12 with the optical axis of the first laser light L11. The optical axis of the first laser light L11 and the optical axis of the second laser light L12 are thus made coaxial, so that the defect def can be detected even when the size of the object under inspection 10 is small.

At the radiation position of the second laser light L12, the angle between a normal to the surface of the object under inspection 10 and the optical axis of the second laser light L12 is not particularly limited to a specific value, but is preferably set at an angle smaller than or equal to 10°. That is, the optical axis of the second laser light L12 preferably extends in the direction perpendicular to the surface of the object under inspection 10 or a direction approximately perpendicular thereto. The second laser light L12 reflected off the object under inspection 10 therefore has a sufficient intensity and can be received by the vibration detector 13.

### 2.3. Moving Stage

The moving stage 17 shown in FIG. 1 includes the base 172, the placement section 174, and the stepper motors 176.

The base 172 spreads in the X-Y plane in accordance with the movement range of the object under inspection 10, and includes, for example, a rail extending along the X-axis and a rail extending along the Y-axis.

The placement section 174 includes, for example, a stage that supports the object under inspection 10 and a slider that slides along each of the rails with which the base 172 is provided. The sliders slide with the aid of the power generated by the stepper motors 176.

The stepper motors 176 are provided on a slider basis. The object under inspection 10 can thus be moved to any position in the X-Y plane. The stepper motors 176 each rotate its output shaft in a predetermined rotational direction, by a predetermined amount of rotation, and at a predetermined rotational speed in accordance with the signal output from the motor controller 184. The placement section 174 can thus be moved with respect to the base 172 in a target direction, by a target amount of movement, and at a target movement speed. Note that the stepper motors 176 can each be replaced with any motor such as a DC motor.

### 2.4. Stage Controller

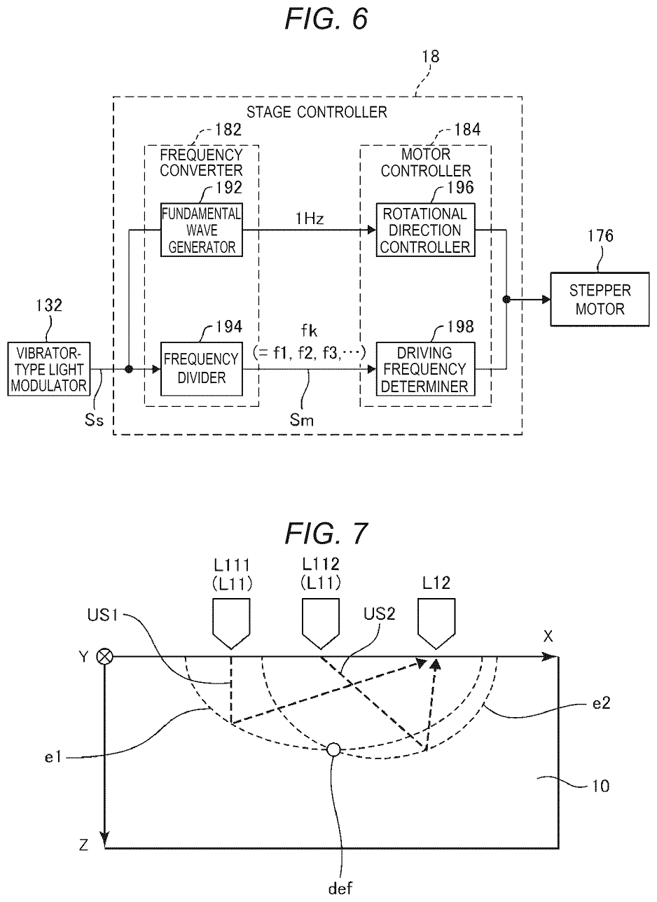

FIG. 6 is a functional block diagram showing functional sections provided in the stage controller 18 in FIG. 1.

The stage controller 18 shown in FIG. 6 includes the frequency converter 182 (second signal generator) and the motor controller 184.

The frequency converter 182 includes a fundamental wave generator 192 and a frequency divider 194.

The reference signal Ss output from the light modulator 132 is input to the fundamental wave generator 192. The fundamental wave generator 192 divides the reference signal Ss to generate a fundamental wave signal having a predetermined frequency, for example, a fundamental wave signal having a frequency of 1 Hz. For example, when the frequency of the reference signal Ss is 32.768 kHz, a 1-Hz fundamental wave signal can be generated by dividing the frequency by two to the 15th power. When the frequency of the reference signal Ss is 4.194303 MHz, the 1-Hz fundamental wave signal can be generated by dividing the frequency by two to the 22nd power. Furthermore, when the frequency of the reference signal Ss is 8.388608 MHz, the 1-Hz fundamental wave signal can be generated by dividing the frequency by two to the 23rd power. Note that the frequency of the fundamental wave signal is not limited to 1 Hz.

The frequency divider 194 is, for example, a digital frequency divider configured with multiple flip-flops. According to the configuration described above, since signals having multiple frequencies can be generated from the reference signal Ss, a drive frequency determiner 198, which will be described later, can select an appropriate frequency in accordance with the moving speed of the object under inspection 10. The frequency generated by the frequency divider 194 is referred to as a drive frequency fk. The drive frequency fk is a variable having different values according to the frequency division number, such as f1, f2, f3, . . . .

Using the thus configured frequency converter 182 can omit the signal generator 982 in the related art. Since the frequency converter 182 described above can be configured with a relatively small number of parts, the number of parts can be further reduced in the laser induced ultrasonic inspection apparatus 1.

The motor controller 184 includes a rotational direction controller 196 and the drive frequency determiner 198.

The fundamental wave signal having the frequency of, for example, 1 Hz is input to the rotational direction controller 196. The rotational direction controller 196 measures an elapsed period for which the stepper motors 176 each rotate in the same direction based on the fundamental wave signal. When a target period has elapsed, the rotational direction controller 196 outputs a control signal used to reverse the rotational direction. The rotational direction of each of the stepper motors 176 can thus be switched at predetermined time intervals. As a result, the object under inspection 10 can travel back and forth.

A signal having the drive frequency fk, which is the stage control signal Sm, is input to the drive frequency determiner 198. When the stepper motors 176 are driven in accordance with a pulse frequency modulation method (PFM method), and the rotational output of the stepper motors 176 is converted into linear motion of the placement section 174, the moving speed of the object under inspection 10 is proportional to the drive frequency fk. The drive frequency determiner 198 therefore only needs to have the function of determining the drive frequency fk based on the proportional relationship described above. A specific example of the thus configured drive frequency determiner 198 may be a multi-phase generation driver.

The signal output from the rotational direction controller 196 and the signal output from the drive frequency determiner 198 are combined with each other and input to the stepper motors 176.

Note that the motor controller 184 may, for example, be a circuit configured with discrete parts, an integrated circuit, or a circuit that is a mixture of discrete parts and an integrated circuit.

In the present embodiment, the vibration of the vibrator 130 is used for the light modulation (modulation of frequency of second laser light L12), the demodulation of the surface vibration signal, the generation of the pulse control signal Sd, the generation of the stage control signal Sm, and the measurement of the elapsed period Δt as described above, so that the number of parts is reduced accordingly.

### 2.5. Defect Detector

The defect detector 16 detects the defect def contained in the object under inspection 10 based on the result of the measurement of the elapsed period Δt. The defect detector 16 can acquire a data set of the radiation position P(X, Y, Lo) and the elapsed period Δt by acquiring the elapsed period Δt with the object under inspection 10 being moved.

When the object under inspection 10 is irradiated with the first laser light L11 at different positions, the difference between the elapsed period Δt1 and the elapsed period Δt2 shown in FIG. 3 reflects the relationship between the radiation positions of the first laser light L11 and the position of the defect def shown in FIG. 1. Therefore, the first laser light L11 is radiated while the moving stage 17 is used to change the radiation position, and the elapsed period Δt is measured. The position of the defect def can thus be identified. A specific example of the operation described above will be described below.

FIG. 7 is a diagrammatic view showing propagation of ultrasonic waves US1 and US2 induced when first laser light L111 and first laser light L112 are radiated to two different locations at the surface of the object under inspection 10. When the first laser light L111 is radiated, the ultrasonic wave US1 propagates along a large number of trajectories including those shown in FIG. 7. Part of the ultrasonic wave US1 is then reflected off the defect def and reaches the surface. The ultrasonic wave US1 having reached the surface is detected by the second laser light L12, for example, in the form of displacement (vibration) of the surface. Similarly, the first laser light L112 induces the ultrasonic wave US2 propagating along a large number of trajectories including those shown in FIG. 7. Part of the ultrasonic wave US2 is then reflected off the defect def and reaches the surface. The ultrasonic wave US2 having reached the surface is detected by the second laser light L12, for example, in the form of displacement (vibration) of the surface.

FIG. 3 shows an example of the waveforms of the displacement d1 derived from the ultrasonic wave US1 reflected off the defect def and the displacement d2 derived from the ultrasonic wave US2 reflected off the defect def. Since the radiation positions of the first laser light L111 and the first laser light L112 differ from each other, the elapsed periods Δt1 and Δt2 until the displacement d1 and the displacement d2 are detected also differ from each other. The defect detector 16 therefore has the function of determining that the defect def is present, for example, when an elapsed period Δt set in advance is smaller than or equal to a reference value of the elapsed period Δt based on the reference value. Note that the defect detector 16 may have the function of determining whether the defect def is present based on another method.

In FIG. 3, it is necessary to change the radiation position of the first laser light L11 between the pulses S11 and S12 of the laser sensing signal S1. Therefore, in the timing chart shown in FIG. 3, the rising edge of a pulse Sm1 of the stage control signal Sm is located between the pulses S11 and S12. Similarly, the rising edge of a pulse Sm2 is located between the pulses S12 and S13. The object under inspection 10 can therefore be moved in a time frame in which the output of the first laser light L11 is not affected.

Furthermore, to move the object under inspection 10 at the timing described above, the phase of the stage control signal Sm is shifted with respect to the laser sensing signal S1 in FIG. 3. In this case, the motor controller 184 may include a phase shifter that is not shown but shifts the phase of the stage control signal Sm with respect to that of the laser sensing signal S1.

The propagation speeds of the ultrasonic waves US1 and US2 can be acquired in advance based on the material and other factors of the object under inspection 10 or through actual measurement. The propagation distances of the ultrasonic waves US1 and US2 can therefore be calculated from the elapsed periods Δt1 and Δt2 and the propagation speeds. The situation in which the ultrasonic wave US1 propagates over the calculated propagation distance shows that the defect def is present somewhere on an ellipse e1 shown in FIG. 7. Similarly, the situation in which the ultrasonic wave US2 propagates over the calculated propagation distance shows that the defect def is present somewhere on an ellipse e2 shown in FIG. 7. Based on the principle described above, the position of the defect def in FIG. 7 can be identified by irradiating the object under inspection 10 at least at three radiation positions with the first laser light L11.

The defect detector 16 detects whether the defect def is present and identifies the position of the defect def based on the principle described above. The object under inspection 10 can thus be invasively inspected. Identifying the position of the defect def as described above while moving the object under inspection 10 allows acquisition of the distribution of the defect def.

Note that examples of the material of which the object under inspection 10 is made may include concrete, metal, resin, ceramic, and glass. Furthermore, examples of the defect def may include a void, a crack, a flake, an interface, foreign matter, and a modified portion.

### 2.6. Image Generator

The image generator 19 generates image data containing the result of the detection of the vibration VB by using the data set acquired by the defect detector 16 described above as point group data. That is, the image generator 19 acquires the position of the object under inspection 10 based on the object-under-inspection position signal Sp acquired from the moving stage 17 by the signal processor 15, and acquires the elapsed period Δt corresponding to the position of the object under inspection 10, that is, the radiation position P(X, Y, Lo). The image data is then generated based on the acquired information.

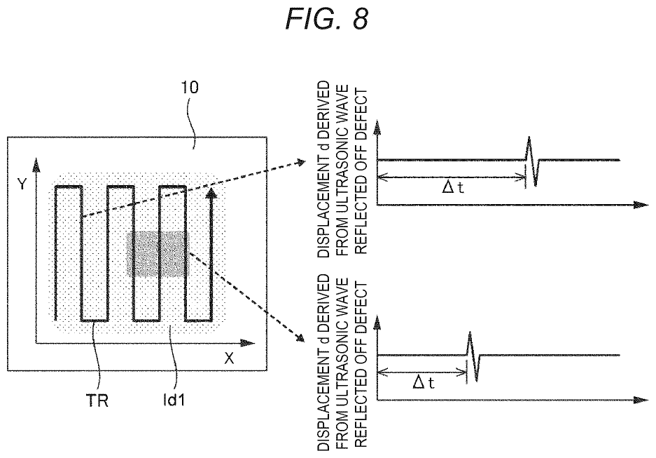

FIG. 8 shows an example of a trajectory TR as a result of scanning the object under inspection 10 with the radiation position of the first laser light L11, and an example of image data Id1 produced by replacing the length of the period elapsed Δt at each position with a color density and mapping the color density in an orthogonal coordinate system having an X-axis and a Y-axis set in the object under inspection 10. FIG. 8 also shows examples of the waveform of the displacement d acquired at two different color density locations in the image data Id1.

The scanning-operation trajectory TR shown in FIG. 8 is a trajectory drawn when the radiation position of the first laser light L11 is shifted in the X-axis direction while being moved back and forth in the Y-axis direction. In the image data Id1 shown in FIG. 8, the color density is low when the elapsed period Δt is relatively long, and the color density is high when the elapsed period Δt is relatively short. Generating the image data Id1 described above allows visual indication of the position of the defect def. The image data Id1 may be displayed by using any method. For example, the image data Id1 may be displayed on a monitor that is not shown or may be projected onto the object under inspection 10.

Note that the scanning-operation trajectory TR and the image data Id1 shown in FIG. 8 are presented by way of example, and are not limited to those shown in FIG. 8.

The functions of the signal processor 15, the defect detector 16, and the image generator 19 are realized, for example, by hardware including a CPU, a memory, and an interface. The hardware is, for example, a microcomputer. The CPU is an abbreviation for “central processing unit”. Examples of the memory may include any nonvolatile storage (ROM), any volatile storage (RAM), and a detachable external storage. Examples of the interface may include a digital input/output port such as a universal serial bus (USB). The functions of the signal processor 15, the defect detector 16, and the image generator 19 are each realized by the CPU executing a program loaded in advance in the memory. Note that in place of or in addition to the method in which the CPU executes the program to realize the functions described above, a method in which hardware, such as a field programmable gate array (FPGA), an application specific integrated circuit (ASIC), or any other integrated circuit, or discrete parts, realizes the functions described above may be used.

### 3. Second Embodiment

A laser induced ultrasonic inspection apparatus according to a second embodiment will next be described.

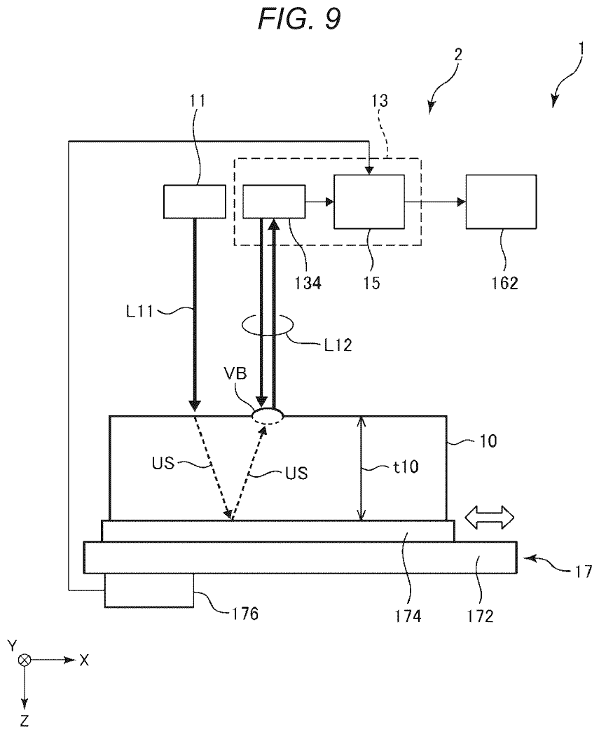

FIG. 9 is a diagrammatic view showing a schematic configuration of a laser induced ultrasonic inspection apparatus 1 according to the second embodiment.

The second embodiment will be described below. In the following description, differences from the first embodiment will be primarily described, and substantially the same items will not be described. Note that configurations that are substantially the same as those in the first embodiment described above have the same reference characters in FIG. 9.

The laser induced ultrasonic inspection apparatus 1 according to the second embodiment is substantially the same as the laser induced ultrasonic inspection apparatus 1 according to the first embodiment except that the thickness of the object under inspection 10 is measured in the second embodiment. Note that FIG. 9 does not show a portion of the configuration.

The laser induced ultrasonic inspection apparatus 1 shown in FIG. 9 includes a thickness measuring section 162 coupled to the signal processor 15. In the laser induced ultrasonic inspection apparatus 1 shown in FIG. 9, when one surface of the object under inspection 10 is irradiated with the first laser light L11, and the induced vibration VB is reflected off the other surface of the object under inspection 10 and then returns to the one surface again to induce the vibration VB, the vibration VB is detected by the second laser light L12. In this case, the elapsed period Δt from the output of the first laser light L11 to the detection of the vibration VB reflects a thickness t10 of the object under inspection 10. That is, let V be the propagation speed of the ultrasonic wave US, and the thickness t10 is determined by Expression (1) below.

$$t 10 = V \cdot Δ t / 2 \qquad ( 1 )$$

Note that Expression (1) described above is satisfied in the strict sense when the optical axis of the first laser light L11 and the optical axis of the second laser light L12 are coaxial. When the two axes are not coaxial, correction may be made based on the separation distance between the two axes and the propagation distance of the ultrasonic wave US calculated from the elapsed period Δt.

The thickness t10 described above can be calculated by the thickness measuring section 162 coupled to the signal processor 15. The laser induced ultrasonic inspection apparatus 1 can therefore invasively inspect the thickness t10 of the object under inspection 10.

The second embodiment described above can also provide substantially the same advantages as those provided by the first embodiment.

In the present embodiment, the moving stage 17 moves the object under inspection 10 in the X-axis and Y-axis directions with respect to the head 2. The distribution of the thickness t10 in the X-Y plane can thus be readily measured.

### 4. Third Embodiment

A laser induced ultrasonic inspection apparatus according to a third embodiment will next be described.

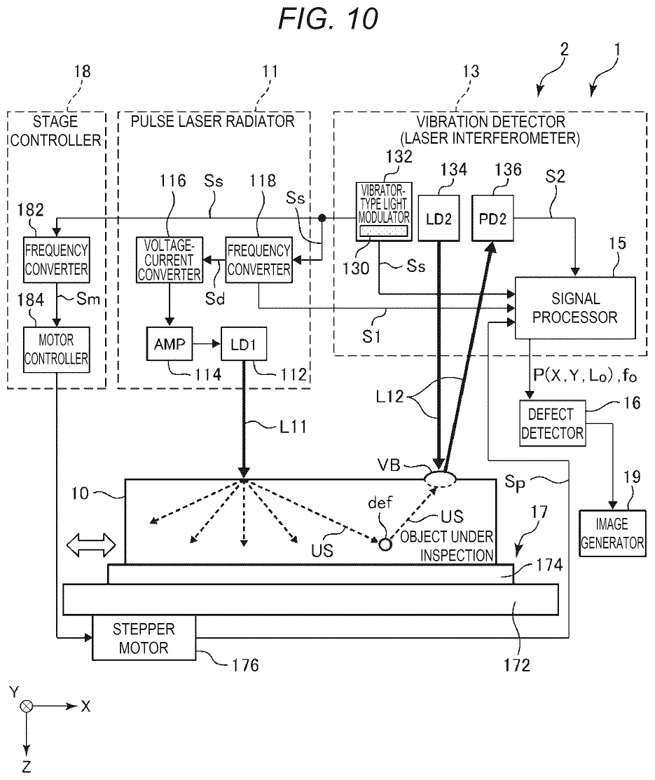

FIG. 10 is a diagrammatic view showing a schematic configuration of a laser induced ultrasonic inspection apparatus 1 according to the third embodiment.

The third embodiment will be described below. In the following description, differences from the first embodiment will be primarily described, and substantially the same items will not be described. Note that configurations that are substantially the same as those in the first embodiment have the same reference characters in FIG. 10.

The laser induced ultrasonic inspection apparatus 1 according to the third embodiment is substantially the same as the laser induced ultrasonic inspection apparatus 1 according to the first embodiment except that the signal processor 15 is configured to calculate the frequency of the vibration VB based on the reference signal Ss.

The signal processor 15 shown in FIG. 10 captures the displacement and the speed of the displacement generated at the surface of the object under inspection 10 due to the vibration VB. The vibration VB can thus be detected.

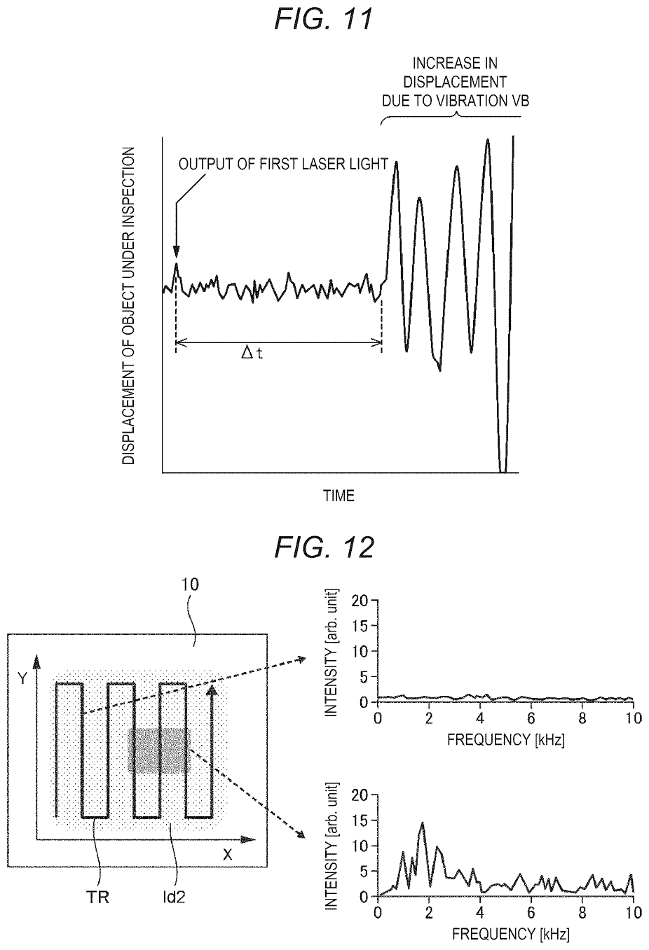

FIG. 11 is a graph showing the waveform of the displacement of the object under inspection 10 produced in association with the vibration VB. In FIG. 11, the horizontal axis represents time, and the vertical axis represents the displacement of the object under inspection 10.

In the graph shown in FIG. 11, almost no displacement is recognized during the elapsed period Δt from the output of the first laser light L11 to the detection of the vibration VB as the displacement of the surface of the object under inspection 10. On the other hand, the amplitude of the displacement increases after the elapsed period Δt. The vibration VB can be detected based on the behavior of the displacement.

The signal processor 15 shown in FIG. 10 has the function of capturing the temporal waveform of the displacement having increased due to the vibration VB shown in FIG. 11 and performing frequency analysis of the temporal waveform. Note that the temporal waveform of the displacement speed may be captured in place of the temporal waveform of the displacement. The frequency analysis can be fast Fourier analysis. The signal processor 15 performs the frequency analysis to generate a frequency analysis result fo. The frequency analysis result fo contains the intensity on a frequency component basis, that is, resonance frequency information and the like. Note that since the temporal waveform of the displacement is generated based on the reference signal Ss, a highly accurate frequency analysis result fo is produced.

In the present embodiment, the temporal waveform of the displacement is acquired while the moving stage 17 changes the relative position of the object under inspection 10 with respect to the head 2. The frequency analysis result fo at each position is then generated from the acquired temporal waveform. That is, the frequency analysis result fo can be generated while the surface of the object under inspection 10 is scanned with the radiation position of the first laser light L11. The defect detector 16 can thus readily acquire a data set of the radiation position P(X, Y, Lo) and the frequency analysis result fo.

The defect detector 16 identifies the state of the defect def, that is, whether a void, a crack, a flake, an interface, foreign matter, a modified portion, or the like is present based on the frequency analysis result fo. Specifically, the frequency analysis result fo reflects a unique frequency in accordance with the state of the defect def. The object under inspection 10 can thus be invasively inspected.

The image generator 19 generates image data containing the result of the detection of the vibration VB by using the data set described above as the point group data.

FIG. 12 shows an example of the trajectory TR as a result of scanning the object under inspection 10 with the radiation position of the first laser light L11, and an example of image data Id2 produced by replacing the frequency analysis result fo at each position with a color density and mapping the color density in the orthogonal coordinate system having the X-axis and the Y-axis set in the object under inspection 10. FIG. 12 also shows examples of the frequency analysis result fo acquired at two different color density locations in the image data Id2.

In the image data Id2 shown in FIG. 12, when the intensities in the vicinity of a frequency of about 2 kHz are smaller than a predetermined threshold, the color densities are low, and when the intensities are greater than or equal to the predetermined threshold, the color densities are high, by way of example. Generating the image data Id2 described above allows visual indication of the position of the defect def.

The sixth embodiment described above can also provide substantially the same advantages as those provided by the third embodiment.

Furthermore, in the present embodiment, the vibration of the vibrator 130 is used for the light modulation, the demodulation of the surface vibration signal, the generation of the pulse control signal Sd, the generation of the stage control signal Sm, and the generation of the temporal waveforms of the displacement and the displacement speed, so that the number of parts is reduced accordingly.

### 5. Advantages Provided by Embodiments Described Above

As described above, the laser induced ultrasonic inspection apparatus 1 according to each of the embodiments described above includes the head 2, the moving stage 17, and the frequency converter 182 (second signal generator). The head 2 includes the first laser light source 112, the frequency converter 118 (first signal generator), and the vibration detector 13 (laser interferometer). The first laser light source 112 irradiates the object under inspection 10 with the pulse-shaped first laser light L11. The frequency converter 118 generates the pulse control signal Sd used to set the repetition frequency of the first laser light L11. The vibration detector 13 uses the second laser light L12 to detect the vibration VB of the object under inspection 10 derived from the ultrasonic wave US induced in the object under inspection 10 by the radiation of the first laser light L11. The moving stage 17, at which the object under inspection 10 is placed, changes the relative position of the object under inspection 10 with respect to the head 2. The frequency converter 182 generates the stage control signal Sm used to control the operation of the moving stage 17.

The vibration detector 13 includes the second laser light source 134, the light modulator 132, the photodiode 136 (light receiver), and the signal processor 15. The second laser light source 134 irradiates the object under inspection 10 with the second laser light L12. The light modulator 132 uses the vibrator 130 to modulate the frequency of the second laser light L12. The photodiode 136 receives the second laser light L12 having traveled via the light modulator 132 and the second laser light L12 having traveled via the object under inspection 10, and outputs the light reception signal S2. The signal processor 15 detects the vibration VB based on the light reception signal S2 and the reference signal Ss.

Furthermore, the frequency converter 118 (first signal generator) generates the pulse control signal Sd based on the reference signal Ss, and the frequency converter 182 (second signal generator) generates the stage control signal Sm based on the reference signal Ss. The vibrator 130 described above is a signal source of the reference signal Ss.

According to the configuration described above, the vibration of the vibrator 130 can be used for the light modulation, the demodulation of the surface vibration signal, the generation of the pulse control signal Sd, the generation of the stage control signal Sm, and the measurement of the elapsed period Δt. Since whether the defect def is present and some other situations can be detected based on the elapsed period Δt, the object under inspection 10 can be invasively inspected. A laser induced ultrasonic inspection apparatus 1 that has a small number of parts, is readily reduced in size, and readily synchronize multiple types of signal processing using the reference signal.

In the laser induced ultrasonic inspection apparatus 1 according to each of the embodiments described above, the signal processor 15 measures the elapsed period Δt from the output of the first laser light L11 from the first laser light source 112 to the detection of the vibration VB based on the reference signal Ss and the laser sensing signal S1 (signal based on pulse control signal Sd).

According to the configuration described above, a laser induced ultrasonic inspection apparatus 1 capable of more accurately measuring the elapsed period Δt is provided.

The laser induced ultrasonic inspection apparatus 1 according to each of the embodiments described above includes the image generator 19, which generates the image data Id1 (image) containing the result of the detection of the vibration VB. The image generator 19 acquires the position of the object under inspection 10 based on the object-under-inspection position signal Sp output from the moving stage 17, acquires the elapsed period Δt corresponding to the position of the object under inspection 10, and generates the image data Id1 based on the position of the object under inspection 10 and the elapsed period Δt.

According to the configuration described above, a laser induced ultrasonic inspection apparatus 1 capable of visually displaying the position of the defect def is provided.

The laser induced ultrasonic inspection apparatus 1 according to each of the embodiments described above includes the defect detector 16, which detects the defect def contained in the object under inspection 10, based on the result of the measurement of the elapsed period Δt.

According to the configuration described above, since the elapsed period Δt reflects the position of the point where the ultrasonic wave US is reflected, a laser induced ultrasonic inspection apparatus 1 capable of detecting whether the defect def is present is provided.

The laser induced ultrasonic inspection apparatus 1 according to each of the embodiments described above includes the thickness measuring section 162, which measures the thickness t10 of the object under inspection 10 based on the result of the measurement of the elapsed period Δt.

According to the configuration described above, a laser induced ultrasonic inspection apparatus 1 capable of invasively inspecting the thickness t10 of the object under inspection 10 is provided.

In the laser induced ultrasonic inspection apparatus 1 according to each of the embodiments described above, the signal processor 15 calculates the frequency of the detected vibration VB based on the reference signal Ss.

According to the configuration described above, since the frequency unique to the state of the defect def is reflected in the frequency analysis result fo, a laser induced ultrasonic inspection apparatus 1 capable of invasively inspecting the object under inspection 10 is provided.

The laser induced ultrasonic inspection apparatus 1 according to each of the embodiments described above includes the image generator 19, which generates the image data Id2 (image) containing the result of the detection of the vibration VB. The image generator 19 acquires the position of the object under inspection 10 based on the object-under-inspection position signal Sp output from the moving stage 17, acquires the frequency analysis result fo (frequency of vibration VB) corresponding to the position of the object under inspection 10, and generates the image data Id2 based on the position of the object under inspection 10 and the frequency analysis result fo.

According to the configuration described above, a laser induced ultrasonic inspection apparatus 1 capable of visually displaying the state of the defect def is provided.

The laser induced ultrasonic inspection apparatus 1 according to each of the embodiments described above includes the defect detector 16, which detects the defect def contained in the object under inspection 10 based on the frequency analysis result fo (result of analysis of frequency of vibration VB).

According to the configuration described above, a laser induced ultrasonic inspection apparatus 1 capable of invasively inspecting the object under inspection 10 based on the state of the defect def is provided.

In the laser induced ultrasonic inspection apparatus 1 according to each of the embodiments described above, the optical axis of the first laser light L11 and the optical axis of the second laser light L12 are parallel to each other.

According to the configuration described above, even when the object under inspection 10 is moved with respect to the head 2, the distance D between the radiation position of the first laser light L11 and the radiation position of the second laser light L12 can be fixed. As a result, when the position of the defect def is calculated from the elapsed period Δt, it is not necessary to make corrections associated with a change in the distance D described above, so that the amount of calculation can be suppressed.

In the laser induced ultrasonic inspection apparatus 1 according to each of the embodiments described above, the signal processor 15 detects the vibration VB by extracting a change in the displacement or the speed of the displacement of the surface of the object under inspection 10 from the light reception signal S2 based on the light reception signal S2 and the reference signal Ss.

According to the configuration described above, a laser induced ultrasonic inspection apparatus 1 capable of accurately detecting the vibration VB in a noncontact manner is provided.

The laser induced ultrasonic inspection apparatus according to the present disclosure has been described above based on the embodiments shown in the drawings, but the present disclosure is not limited thereto.

For example, the laser induced ultrasonic inspection apparatus according to the present disclosure may be provided by replacing each portion in any of the embodiments described above with any constituent element having substantially the same function, or may be provided by adding any constituent element to any of the embodiments described above. In addition, the laser induced ultrasonic inspection apparatus according to the present disclosure may have a configuration that is a combination of two or more of the embodiments described above.

What is claimed is:

1. A laser induced ultrasonic inspection apparatus comprising:
a head including a first laser light source configured to irradiates an object under inspection with pulse-shaped first laser light, a first signal generator configured to generate a pulse control signal used to set a repetition frequency of the first laser light, and a laser interferometer configured to use second laser light to detect vibration of the object under inspection that is derived from an ultrasonic wave induced in the object under inspection by the radiation of the first laser light;
a moving stage at which the object under inspection is placed and which is configured to change a relative position of the object under inspection with respect to the head; and
a second signal generator configured to generate a stage control signal used to control an operation of the moving stage,
wherein the laser interferometer includes
a second laser light source configured to irradiate the object under inspection with the second laser light,
a light modulator configured to use a vibrator to modulate a frequency of the second laser light,
a light receiver configured to receive the second laser light traveling via the light modulator and the second laser light traveling via the object under inspection, and output a light reception signal, and
a signal processor configured to detect the vibration based on the light reception signal and a reference signal,
the first signal generator is configured to generate the pulse control signal based on the reference signal,
the second signal generator is configured to generate the stage control signal based on the reference signal, and
the vibrator is a signal source of the reference signal.

2. The laser induced ultrasonic inspection apparatus according to claim 1, wherein
the signal processor is configured to measure an elapsed period from output of the first laser light from the first laser light source to detection of the vibration based on the reference signal and the pulse control signal.

3. The laser induced ultrasonic inspection apparatus according to claim 2, further comprising an image generator configured to generate an image containing a result of the detection of the vibration,
wherein the image generator is configured to
acquire a position of the object under inspection based on an object-under-inspection position signal output from the moving stage,
acquire the elapsed period corresponding to the position of the object under inspection, and
generate the image based on the position of the object under inspection and the elapsed period.

4. The laser induced ultrasonic inspection apparatus according to claim 2, further comprising:
a defect detector configured to detect a defect contained in the object under inspection based on a result of the measurement of the elapsed period.

5. The laser induced ultrasonic inspection apparatus according to claim 2, wherein
the signal processor is configured to measure a thickness of the object under inspection based on a result of the measurement of the elapsed period.

6. The laser induced ultrasonic inspection apparatus according to claim 1, wherein
the signal processor is configured to calculate a frequency of the detected vibration based on the reference signal.

7. The laser induced ultrasonic inspection apparatus according to claim 6, further comprising an image generator configured to generate an image containing a result of the detection of the vibration,
wherein the image generator is configured to
acquire a position of the object under inspection based on an object-under-inspection position signal output from the moving stage,
acquire the frequency of the vibration corresponding to the position of the object under inspection, and
generate the image based on the position of the object under inspection and the frequency of the vibration.

8. The laser induced ultrasonic inspection apparatus according to claim 6, further comprising:
a defect detector configured to detect a defect contained in the object under inspection based on a result of analysis of the frequency of the vibration.

9. The laser induced ultrasonic inspection apparatus according to claim 1,
wherein an optical axis of the first laser light and an optical axis of the second laser light are parallel to each other.

10. The laser induced ultrasonic inspection apparatus according to claim 1,
wherein the signal processor is configured to detect the vibration by extracting a change in displacement or a speed of the displacement of a surface of the object under inspection from the light reception signal based on the light reception signal and the reference signal.
